(19) United States
(12) Patent Application Publication
(10) Pub. No.: US 2006/0102193 A1
(43) Pub. Date: May 18, 2006

(54) Ultrasonic cleaning and washing apparatus for fruits and vegetables and a method for the use thereof

(76) Inventors: Yakov Lyubchik, Rehovot (IL); Rudolf Botner, Shderot (IL); Yonatan ` Hen, Yizrael (IL); David Erel, Ramat Hasharon (IL)

Correspondence Address: Edward Langer;Shiboleth Yisraeli Roberts Zisman & Co, 350 Fifth Avenue, 60th Floor, New York, NY, 10118, US

(21) Appl. No.: 10/519,479

(22) PCT Filed:
(86) PCT No.: PCT/IL03/00561

Related U.S. Application Data
(60) Provisional application No. 60/393,811, filed on Jul. 8, 2002.

(51) Int. Cl. B08B 3/12; B08B 3/00

(52) U.S. Cl. 134/1; 134/34; 134/184

(57) ABSTRACT

The invention provides a method and an apparatus for washing and cleaning fruits and vegetables. The apparatus has a degassing means (14); a washing tank (26) which accommodates at least one item for cleaning; an ultrasonic means (28); at least one water pumping means (32); a water jetting means (62) for directing a plurality of jets of water towards the at least one cleaning item to halt circulation and motion of water in the washing tank (26) and concurrently to bring the rotation and motion of the at least one cleaning item to halt within the shortest period of time, a holding means (52, 70) to facilitate passage of ultrasonic energy through the water to optimally penetrate the at least one cleaning item immersed therein; and a control means (16) for programming and executing relevant process parameters in the operation of the apparatus.

### FIELD OF THE INVENTION

The present invention generally relates to an apparatus for ultrasonic cleaning and washing and to a method for the use thereof, and in particular, to an apparatus for cleaning, washing, disinfecting, decontaminating, and sanitizing any soft, water-resistant items which are ultrasonic-energy absorptive, such as fruits and vegetables, by the programmed application of ultrasonic energy in baths of water.

### BACKGROUND OF TEE INVENTION

The present invention is an improvement upon a prior patent, U.S. Pat. No. 5,113,881 to Lin and Erel (19 May, 1992) wherein the idea was initially proposed to use ultrasonic energy vibrations for dynamic cleaning and disinfecting of fruit and vegetables.

Although the prior art was an advance over existing devices and methods for cleaning produce, the present invention provides a method that is even more efficient and a device that does a more thorough cleaning than heretofore known using a method having a shorter duration cleaning cycle. In particular, the present invention introduces the novel steps of degassing the water used for the cleaning and washing bath prior to introduction of ultrasonic energy.

In the prior art, stirring was enabled either by rotating the container, such as a basket, or by utilizing a centrifugal pump to agitate the water itself. The stirring action produced spin of the contents in the bath. The present invention, by contrast, is specifically designed to take advantage of the well-known cavitation effect of ultrasonic energy to efficiently and effectively clean soft, water-resistant items. In addition, between pulse cycles of ultrasonic energy, jets of water are sprayed in opposite directions from nozzles disposed on opposing sides of the washing tank towards the cleaning items to wash away contaminants freed from the surfaces and cause the cleaning items to rotate, thus exposing all surfaces to the cleaning process.

It is well-known that fruits and vegetables are subjected to wide-spread application of pesticides, herbicides, and fungicides in order to prevent drastic reductions in the yields of cash crops as a result of damage incurred by plants and trees during their growth cycle from the presence or action of insects, worms, fungi, viruses, and bacteria Concurrently, there is a growing public awareness that the regular consumption of minute residues of toxic pesticides, herbicides, and fungicides, as well as microbiological and other surface contaminants, represents a cumulative and long-term health hazard.

Furthermore, it is becoming increasingly clear to the public that the continuing and daily use of toxic agents will only increase, and that new, more active poisonous agents are being introduced daily to fight insects and microbiological contaminants which have become immune to the existing products. Moreover, the decreasing availability of water will increase the usage of secondary, graywater sources for irrigation, adding an additional health vector for the potential spread of disease and chemical and biological contamination of food crops.

The only means commonly available to clean and wash away all existing surface contamination from fruit and vegetables with the aid of detergents and disinfectants is by hand washing at the domestic level, and by submerging, stirring, and washing at the industrial or public kitchen level. Extensive tests have shown that both methods are inefficient in removing physical, biological, and chemical surface contaminants to a satisfactory degree, especially from small, clustered fruit such as grapes or from leafy vegetables.

Very often people use only tap water to wash fruit or vegetables because of the effort and time required for a thorough cleansing. Using detergents and chemicals entails using protective rubber or plastic gloves to protect the hands from contact with harsh abrasives or from the adverse affects of these substances on the skin due to extended exposure.

Thus, while attempts have been made to address one or another of the abovementioned problems, they do not fulfill the need for a relatively easy-to-use, and effective apparatus and method for cleaning, disinfecting, decontaminating, sanitizing, and washing fruits and vegetables resulting in insect-free produce. Furthermore, the invention is equally effective in cleaning a wide variety of soft items so as to make them free from surface-disposed chemicals, microorganisms, and from undesirable surface dirt and other contaminants.

### SUMMARY OF THE INVENTION

Accordingly, it is a principal object of the present invention to overcome the abovementioned disadvantages of prior art methods for cleaning and washing of any soft water-resistant items which are ultrasonic-energy absorptive by providing an ultrasonic energy cleaning and washing apparatus.

It is another object of the present invention to provide an apparatus suitable for the ultrasonic cleaning of fruit and vegetables, which facilitates removal of practically all surface-disposed and attached residues of contaminants such as mud, biological wastes, microbiological flora such as mold, fungi, worms, bacteria, germs, and surface-disposed chemicals such as herbicides, pesticides, fungicides, fertilizer residue, and the like, from rough or smooth surfaces of fruit and vegetables of all types. This apparatus, in one embodiment of the invention, is applicable in industrial facilities utilizing batch processes, while in another embodiment, is particularly suited for use in facilities employing continuous processing. The apparatus is therefore adaptable for use in both institutional and domestic applications.

It has been demonstrated by the inventor that only by applying ultrasonic vibration of a given duration, intensity, direction, and frequency can the surface-disposed contamination level on fruits and vegetables of all kinds be reduced up to 99%, without damaging the product's skin and without using any chemical agent such as detergents and disinfectants

It is still another object of the invention to provide an apparatus which enables cleaning of the generally inaccessible portions of fruit or vegetables or cleaning soft fruit or vegetables which are inherently unsuitable for effective washing such as grapes, raisins, strawberries, lettuce, and the like by application of ultrasonic energy which dramatically improves the cleaning of all types of fresh produce. Tests conducted using the method of the invention revealed that insects that populate such inaccessible areas detach themselves from infested products immediately after being subjected to US-generated cavitation

Although the description given herein is of a method for cleaning and washing fruits and vegetables, this application is given only by way of example, since it is a principle use of the apparatus of the present invention in a preferred embodiment, but it should be understood that the inventive apparatus is equally suited for use in many other cleaning applications as may be obvious to those skilled in the art. For example, the apparatus may be used for cleaning any items composed of soft, ultrasonic-energy absorptive materials unaffected by submersion in water, such as silicon or plastic as well as cut flowers or flowering plants. (Hereinafter the term “cleaning item” is employed to convey this wider application.)

One noteworthy advantage of the method of the present invention over prior art is its ability to rejuvenate and refresh leafy vegetables and flowers. Normally, when such items for cleaning are submerged in water they absorb a quantity of the water, but this in itself does not achieve the rejuvenation and refreshing effect of the method of the present invention. Even longer submersion in water will not give the same results. In contrast, however, when cleaned and washed with the apparatus of the present invention, wilted or limp leafy vegetables such as lettuce, parsley, and dill which are submerged in water, exposed to US energy for up to 5 minutes, and then removed from the apparatus, they become erect and regain their fresh appearance.

The same rejuvenation effect occurs when the stems and leaves of flowers are submerged in water and exposed to US energy for several minutes during which time the flowers themselves are kept above the surface of the water. In one embodiment of the invention, vertical, needle-like antennas distribute the US energy in the water in a manner such that all the leaves are provided with maximum exposure levels and to a cumulative amount of US energy. Flowers with downward bent stems become erect after such exposure and submersion in the water of the apparatus. An additional benefit of this is that flower life (bloom) is extended several days longer than that of untreated flowers.

The apparatus in this embodiment and application, is fitted with baskets of different sizes in accordance with the length of the flower stems to be cleaned. Allowance is made for the placement of antennas so that they can pass through the basket bottoms in a manner so that the stems of the flowers rest on the floor of the basket.

In another embodiment of the invention, the basket also serves as an antenna, while in still another embodiment, the perforated basket is separated by a short space, comprising generally the bath floor, from the US energy which is transmitted into the water. The US energy transmitted into the water enters through the perforations into the basket holding items to be cleaned/washed.

Although the method of the present invention comprises a number of steps known to those skilled in the art, the cleaning method, in one or more embodiments of the invention, improves on them by providing, in addition, the following novel features:

1) degassing water used for washing in a separate tank prior to ultrasonic cleaning, by applying vacuum, water circulation and US energy in any combination thereof, a process which enables continuous cleaning with degassed water.

2) applying a vacuum to at least one of the ultrasonic and water circulation systems of the apparatus to prevent the intrusion of air, thus enhancing the removal of air and the cleaning process;

3) jets of water used for washing are directed from nozzles strategically located around the washing tank towards the cleaning items in a manner to prevent air intrusion while promoting water circulation and deceleration (counter-circulation) and to forcefully remove surface contaminants from cleaning items that were weakened by the US energy, and changing the position of the product in respect to the US source;

4) an unloading means, which may be a basket, is provided for the washing tank.

The unloading means is adaptable either to an open washing tank or a tank under vacuum. The basket may be either completely removable, or rotatable so as to provide for unloading and removal of cleaning items.

It should be noted that the parameters for water circulation and pressure, and for the intensity and duration of ultrasonic energy applied, are adjustable in accordance with the sensitivity to the cleaning item(s) under process, such as leafy vegetables, soft fruit, hard fruit, flowers, and the like, in order to prevent damage.

In a preferred embodiment of the invention, degassing of water is performed parallel to the washing process. Degassing is performed under vacuum with or without circulating the water; with or without introduction of ultrasonic energy; and with or without pre-warming the wash water to a predefined temperature suitable for use with given cleaning items, in any combination thereof.

Thus, in accordance with a preferred embodiment of the present invention, there is provided a cleaning and washing apparatus comprising a degassing means for providing degassed water for cleaning and washing; a washing tank utilizing the degassed water and which accommodates at least one cleaning item; an ultrasonic means to generate pulses of ultrasonic energy in the water of the washing tank; a water jetting means for directing jets of water towards the at least one cleaning item; and opposite directed jets to bring the product to a halt within the shortest period; at least one water pumping means for circulating the water of the washing tank; a holding means for holding the at least one cleaning item in the water of the washing tank in a manner to allow ultrasonic energy to easily pass through the water and around the at least one cleaning item contained therein; and a control means for programming and executing relevant process parameters in the operation of said ultrasonic cleaning apparatus for cycling said at least one cleaning item in an appropriate cleaning cycle.

There is further provided, in an embodiment of the invention wherein the washing tank is maintained under vacuum, a cover for the washing tank to prevent air intrusion and to contain the at least one cleaning item in a submerged position when the washing tank is filled with water.

Moreover, there is provided a method for cleaning and washing the at least one cleaning item comprising the steps of:

degassing a quantity of water prior to being used for washing the at least one cleaning item;

placing the at least one cleaning item in a holding means within a washing tank;

supplying degassed water to the washing tank to a level enabling the holding means containing the at least one cleaning item to be submerged in the water;

transmitting pulses of ultrasonic energy into the degassed water in the washing tank to produce a cavitation effect resulting from the action of the implosion of a plurality of micro-water vapor bubbles formed in the water which introduce shock waves to act upon the at least one cleaning item;

subjecting the at least one cleaning item to a suitable cleaning cycle by selecting relevant process parameters from operating controls provided on the apparatus itself;

providing pulse circulation of the water in the washing cycle so as to prevent air intrusion and to cause the at least one cleaning item in the washing tank to alternatively revolve around itself and to remain stationary during a specific period between each said revolving period, thereby exposing all surfaces to cavitation cleaning action; removing the at least one cleaning item from the washing tank; and

There is provided a method further comprising the steps of:

applying a vacuum to one of the degassing and washing tanks to enhance the cavitation cleaning process;

providing an unloading means for removing the at least one cleaning item from the washing tank; and

rinsing the treated and cleaned at least one cleaning item under tap water.

In another embodiment of the invention for use in domestic applications, the washing apparatus is provided with only a washing tank and the degassing of the water is performed in the washing tank itself prior to the cleaning and washing cycle, preferably, while under vacuum. An item for cleaning is placed inside a holding means, such as a basket.

It should be appreciated that the washing tank is provided with a cover which locks to hold items securely within the washing tank and the tank itself, with the cleaning items already placed inside a holding means, such as a basket. The washing tank is built to withstand unusual pressure or to operate under vacuum conditions.

In another embodiment of the invention, the degassing tank is disposed above the washing tank with the footprint of the degassing tank disposed within the footprint of the washing tank with water flowing to the washing tank by gravitic action or gravity assisted pumping. Optionally, the degassing tank is disposed adjacent to the washing tank and at the same level and the water flow is enabled primarily by a pumping means.

In yet another embodiment of the invention with degassing under vacuum, the washing apparatus provides for water circulation in the vertical plane with or without cavitation generated by an ultrasonic means. The cleaning items are washed while the washing tank is under vacuum.

In an embodiment of the invention for domestic applications, the circulating and degassing functions may be separated or provided for in the same tank, either with or without a vacuum. Optionally, the water may be degassed in the washing tank In yet a further embodiment of the invention, the apparatus is provided without a degassing means. Cleaning is accomplished by utilizing opposing sets of water jets to circulate the water in at least one level onto and around at least one submerged cleaning item causing the at least one cleaning item to rotate in the agitated water exposing all surfaces to the cleaning action without damaging the face of the at least one cleaning item.

Increased agitation and circulation of the water and forced rotation of the at least one cleaning item are introduced by both the dynamics of the cavitation effect from ultrasonic energy transmitted through the water of the washing tank and by the water jets directed in opposing directions against the at least one cleaning item. The water jets are programmable so as to operate in alternating cycles for slowing and stopping the circulation of the water even beyond the natural friction of the sides of the washing tank, which need not be circular. Both the cleaning items and the water are quickly calmed and set at rest between the circulating cycles in the cleaning process by the use of these water jets so as to enhance and optimize the cleaning effect of ultrasound energy.

It should be understood that the manner of water circulation in the washing tank is such that it does not introduce additional air into the water during water circulation beyond the level of air that was present in the water after leaving the degassing tank.

In one embodiment of the invention, the washing tank is non-circular with its corner imposing larger halting friction on the at least one cleaning item than provided by a circular washing tank.

The advantages of the water jet circulation and ultrasonic energy cavitation effect of the invention still provide, in almost all domestic applications, up to 90% efficiency in the cleaning of the surfaces of produce or other soft, ultrasonic-energy absorptive items in the removal of pathogens and surface contaminants as verified in rigorous laboratory tests. In this respect, the ultrasonic energy cleaning and washing apparatus ensures that the most dangerous threats from coliforms, E-coli, and salmonella are destroyed even without the use of detergents, disinfectants, and the like.

Another embodiment of the invention comprises the same washing tank as described heretofore, but without a water circulation means, but with a plurality of perforated cylinders which serve as holders for flower stems. In this embodiment, the holders are strategically arranged in the water tank to accommodate flowers with their stems and leaves submerged and the flowers held above the water surface. Cavitation takes place within the holders from the ultrasonic energy directed into the water tank from transducers located in proximity to, either below and/or on a side of, the container comprising the washing tank.

Even where circulation of water is used, the cleaning items remain stationary between circulating cycles so as to maximize and optimize the effect of ultrasonic energy. In the case where circulation means are not employed, the cleaning items are thus exposed to more pulses of ultrasonic energy.

Optional features in some embodiments of the invention include an unloading mechanism for the washing tank, for use with a regular washing tank operated without a vacuum, as well as for a washing tank working under a vacuum.

In another embodiment of the invention there is provided a washing apparatus that operates under a continuous processing of cleaning items. The cleaning items are moved along the length of the washing tank by pulsating water currents as with the batch process described hereinbefore and washed with agitated, circulating water from pairs of pulsating water jets strategically disposed at opposing points about the washing tank. Mechanical means, such as a movable conveyer system, is an option usable for moving cleaning items in the continuous process embodiment of the invention.

Other features and advantages of the present invention will become apparent from the drawings and from the detailed description given below.

### BRIEF DESCRIPTION OF THE DRAWINGS

For a better understanding of the invention with regard to the embodiments thereof, reference is made to the accompanying drawings, in which like numerals and alphabetic letters designate corresponding elements or sections throughout, and in which:

FIG. 1 is a partial, cut-away view of a preferred embodiment of the apparatus of the present invention;

FIG. 2 is a front view, in orthographic projection (View A, as indicated by the arrow in FIG. 1), of the embodiment of the invention of FIG. 1;

FIG. 3 is a lateral view, in orthographic projection (View B, as indicated by the arrow in

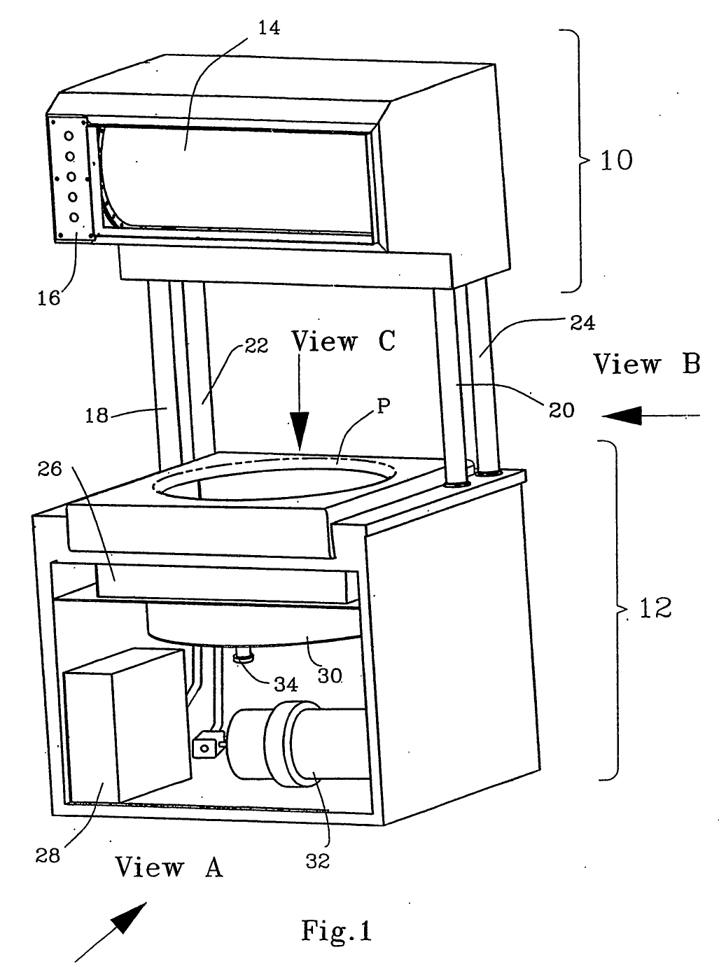

FIG. 1), of the embodiment of the invention shown in FIG. 1;

FIG. 4 is a top view of the lower unit of the apparatus (View C as indicated by the arrow in FIG. 1), of the embodiment of the invention of FIG. 1;

FIG. 5 is a front view of another embodiment of the invention wherein degassing of water and washing are both provided in the washing tank;

FIG. 6 is a lateral view, in orthographic projection View D as indicated by the arrow in FIG. 5), of the embodiment of the invention shown in FIG. 5;

FIG. 7 is a lateral orthographic view of yet another embodiment of the invention downsized and suitable for domestic use;

FIG. 8 is a frontal view A′, of another embodiment of the invention of FIG. 1 adapted for cleaning flowering plants;

FIG. 9 is a top view C′ of the lower unit of the inventive apparatus as shown in FIG. 8 illustrating an arrangement of flower-holding cylinders and a magnified detail thereof;

FIG. 10 is a lateral view of yet another embodiment of the invention providing for an unloading means in a continuous process apparatus; and

FIG. 11 is a front view E of the embodiment of the invention as shown in FIG. 10.

### DETAILED DESCRIPTION OF THE PREFERRED EMBODIMENTS

Referring now to FIG. 1, there is shown a partial, cut-away view of a preferred embodiment of the apparatus of the present invention.

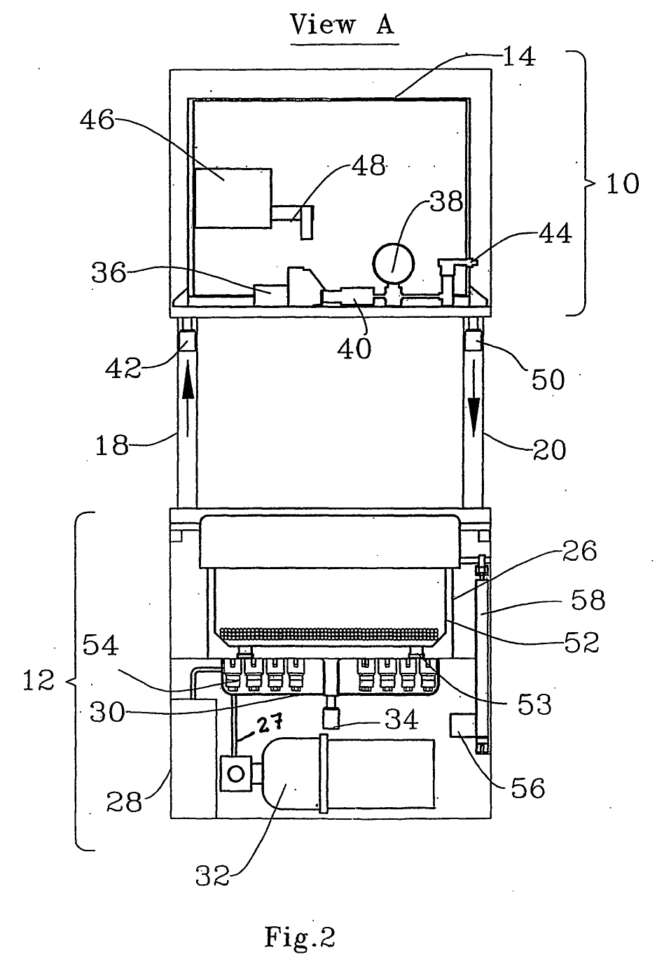

The apparatus, in this embodiment of the invention (also as illustrated in FIGS. 2-4), generally comprises two units, an upper unit 10 and a lower unit 12. Upper unit 10 houses a water degassing tank 14 shown in a cutaway view and a control panel 16 for electrical and hydro-mechanical control and operation of the apparatus. Supporting legs 18, 20, 22, and 24 are constructed of hollow, rigid, tubular material, such as plastic or metal, and connect upper unit 10 and lower unit 12 of the apparatus to serve as a convenient conduit for passing degassed water from the upper unit 10 to the lower unit 12 and for accommodating electrical wires for passing electromechanical control signals and power, between the two units.

Lower unit 12 houses a washing bath 26 which receives degassed water from the upper unit 10 through supporting leg 20. Washing bath 26 is filled to a pre-determined level and items for cleaning are placed through opening P either directly into the washing bath 26 or into a holding means (not shown—FIG. 2), such as a wire netting or a perforated basket to facilitate convenient and efficient removal of items after processing in the cleaning and washing apparatus.

There are also electromechanical devices (not shown) for implementing programmable cleaning and washing cycles, as is known to those skilled in the art. The lower unit 12 of the apparatus generally includes an ultrasonic generator 28, at least one array of ultrasonic transducers (not shown) housed in a transducer unit 30, a water circulation pump 32 for circulating the water of washing bath 26, and a motorized water drain 34 for draining washing bath 26 upon completion of the cleaning/washing cycle.

Ultrasonic energy from ultrasonic generator 28 is propagated through the water in washing bath 26 by means of transducers (not shown) within transducer unit 30 disposed below washing bath 26. Pre-programmed, alternating cycles of washing and ultrasonic cleaning effectively remove surface contaminants and sanitize the items in accordance with the principles and method of the invention.

The cleaning is achieved by the creation of small, vapor bubbles during the under-atmospheric pressure half cycle of the ultrasonic wave due to the quick evaporation of water under a lower pressure than atmospheric on the over-atmospheric pressure half of the cycle. The micro-water vapor bubbles collapse sending shock waves into the water. These shock waves collide with the surfaces of the cleaning items, destroy microorganisms, release dirt adhering to the surfaces, disturb and displace attached insects. Water circulation in part of the operating cycle of the inventive apparatus assists this process by washing the released contaminants and dead micro-organisms from the face of the cleaning items, while also rotating these items so that all faces are exposed to the ultrasonic source. Due to the softness of the cleaning items, the ultrasound energy is absorbed by them and does not propagate throughout the whole volume of the washing tank as happens when cleaning harder cleaning items. Thus, there is a need to rotate the cleaning items and change their position in respect to the source of the ultrasonic energy.

FIG. 2 shows a front cut-away view (View A, as indicated by the arrow in FIG. 1) of the embodiment of the apparatus of the invention of FIG. 1.

Major components of upper unit 10 are shown in detail and comprise: water degassing tank 14 and various control and monitoring devices as is commonly known to those skilled in the art. In the embodiment of the apparatus of the invention shown here, these devices include a vacuum pump 36, a vacuum gage 38, and an electromechanical valve 40 which controls the connecting line to vacuum pump 36. Water is drawn into the degassing tank 14 in upper unit 10 by the main supply pressure through one of the hollow supporting legs 18 when a motorized valve 42 is opened for water input as part of a programmed cleaning and washing cycle of the apparatus. The water level in degassing tank 14 is monitored by water level sensor 44. A water circulating pump 46 is provided to assist transfer of the degassed water from upper unit 10 through outlet pipe 48 and from there to the lower unit 12 through supporting leg 20 when motorized valve 50 is opened to begin the clearing and washing cycle to be performed in the lower unit 12. Since the degassing tank 14 is under vacuum, valve 40 is operated to open the system to air in order to allow the water to flow to and from the degassing tank 14, as needed.

The lower unit 12 of the apparatus comprises a washing bath 26 which is provided with a convenient holding means 52, which, for example, is a basket for holding items to be cleaned and washed, and which readily facilitates inserting and removing cleaning items from washing bath 26. The holding means 52 (hereinafter referred to as basket 52) may be fixed, rotatable, or completely removable.

An optional, hand-movable sprayer (not shown), disposed above the opening to water bath 26, is operated by a manual sprayer valve (not shown) connected by pipe 27 to water pump 32 to initially rinse the contents of basket 52 with tap water.

Washing bath 26 may have any shape, such as circular, square, or rectangular, but in the embodiment shown in FIG. 2, washing bath 26 is circular. The basket 52 may be made of any water-resistant material suitable for holding items to be cleaned, but in the embodiment of the invention illustrated, is made from perforated metal plates or wire netting to allow water to freely circulate around items placed within basket 52 as well as to provide for the unobstructed passage of ultrasonic energy through and around cleaning items for maximum effect. Basket 52 is provided with feet 53 to maintain a distance above the floor of washing bath 26 for effective water circulation and absorption of ultrasonic energy.

A separate, water-proof compartment 30 constructed underneath and in close proximity to the washing bath 26 covers and protects arrays of one or more ultrasonic transducers 54 which generates ultrasonic energy when activated by ultrasonic generator 28. The ultrasonic energy creates micro-water vapor bubbles in the water which result in a cavitation effect in washing bath 26 which agitates any cleaning items placed within the basket 52 of washing bath 26 and greatly enhances cleaning and decontamination of surface contaminants on the items submerged in the water. Water pump 32 provides jets of water directed in opposing directions at the item(s) for cleaning to cause them to rotate and expose all recesses and inverted surfaces and bring these hard to clean surfaces in direct contact with the water. This combination of the application of pulses of ultrasonic energy and water jets successfully removes contaminants from cleaning items in a manner and duration not heretofore achieved.

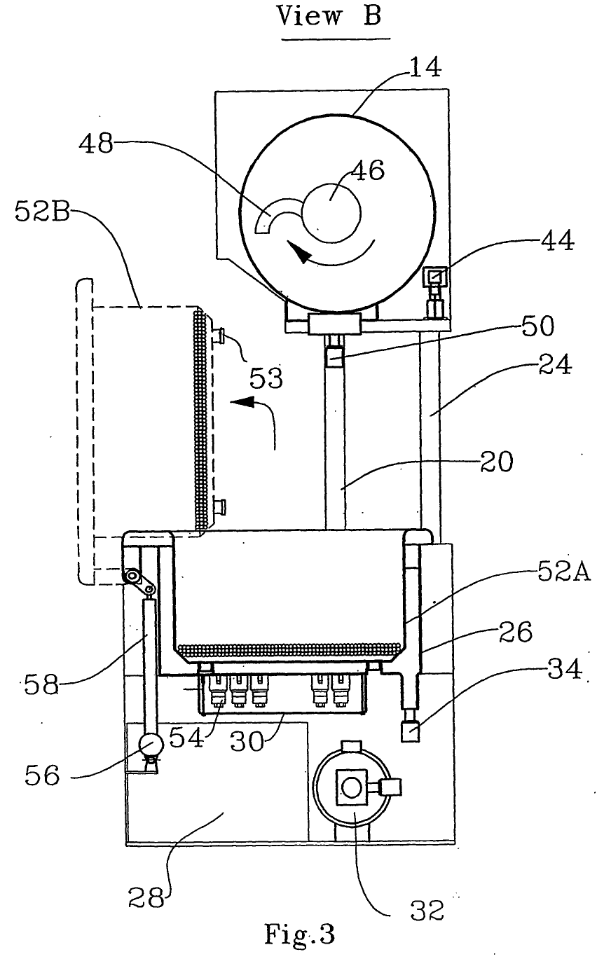

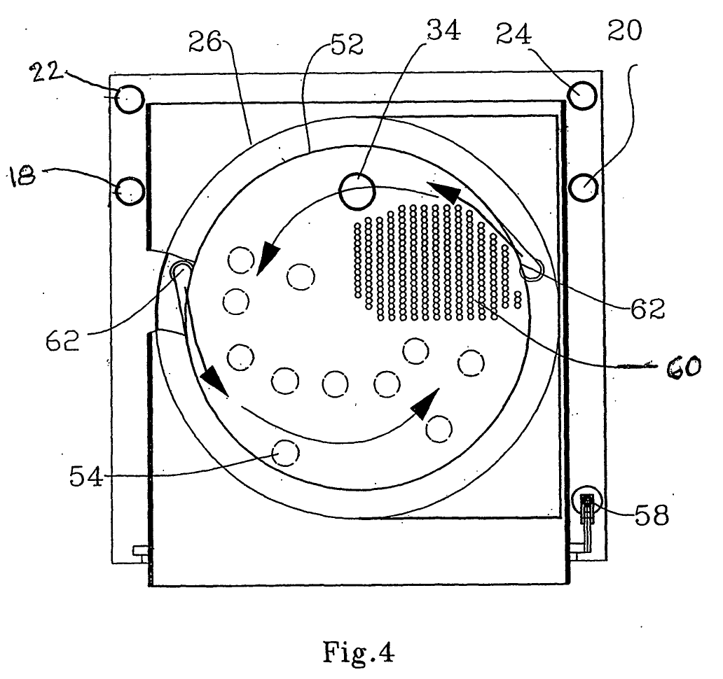

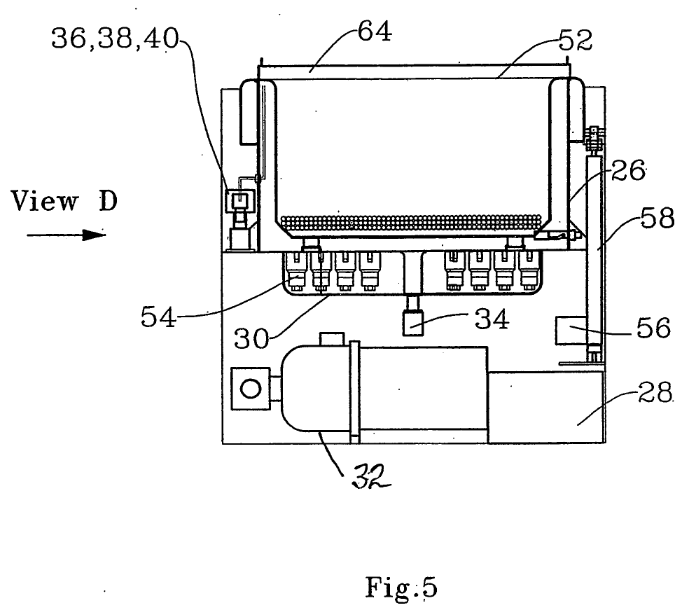

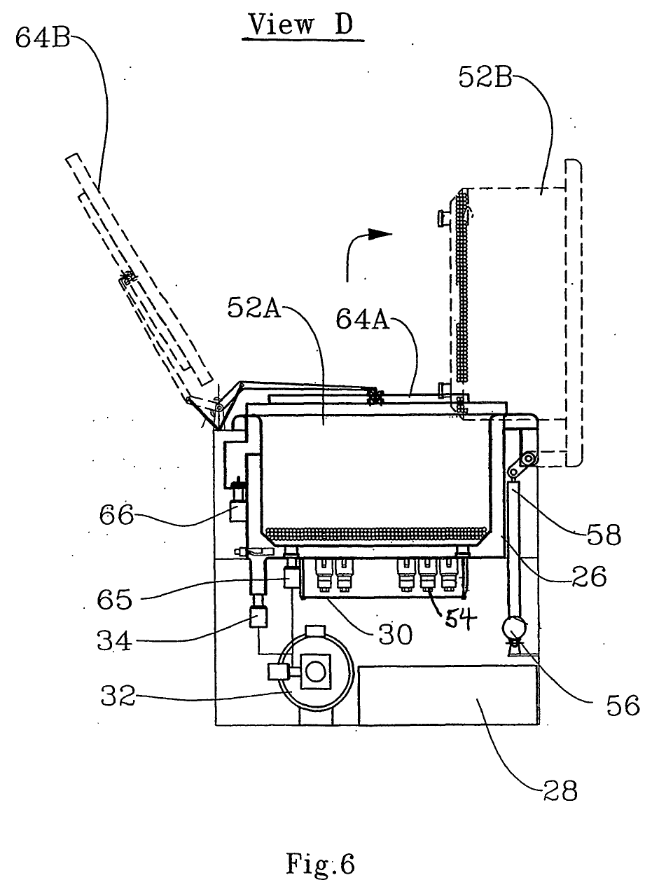

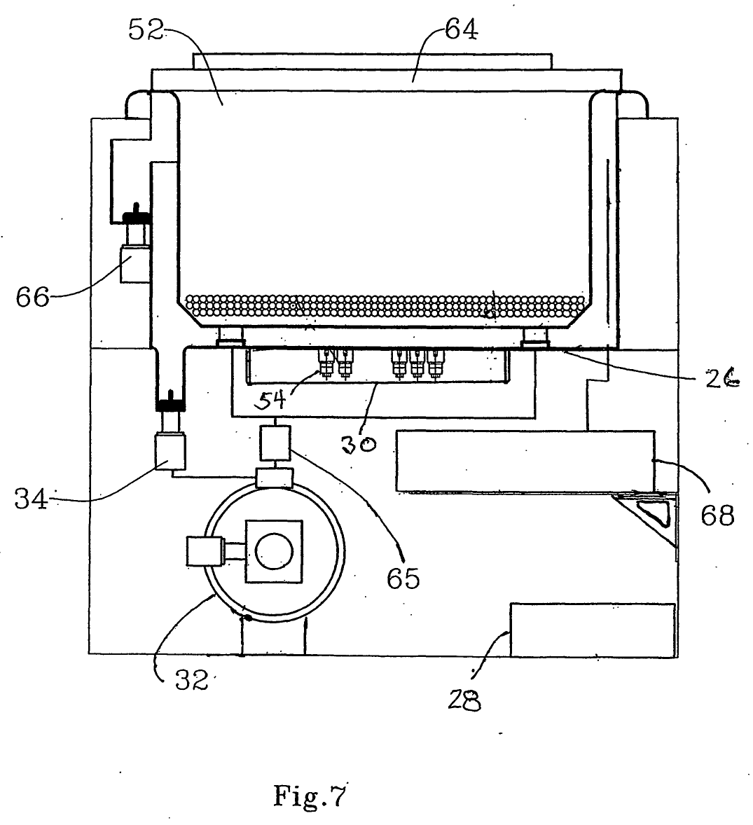

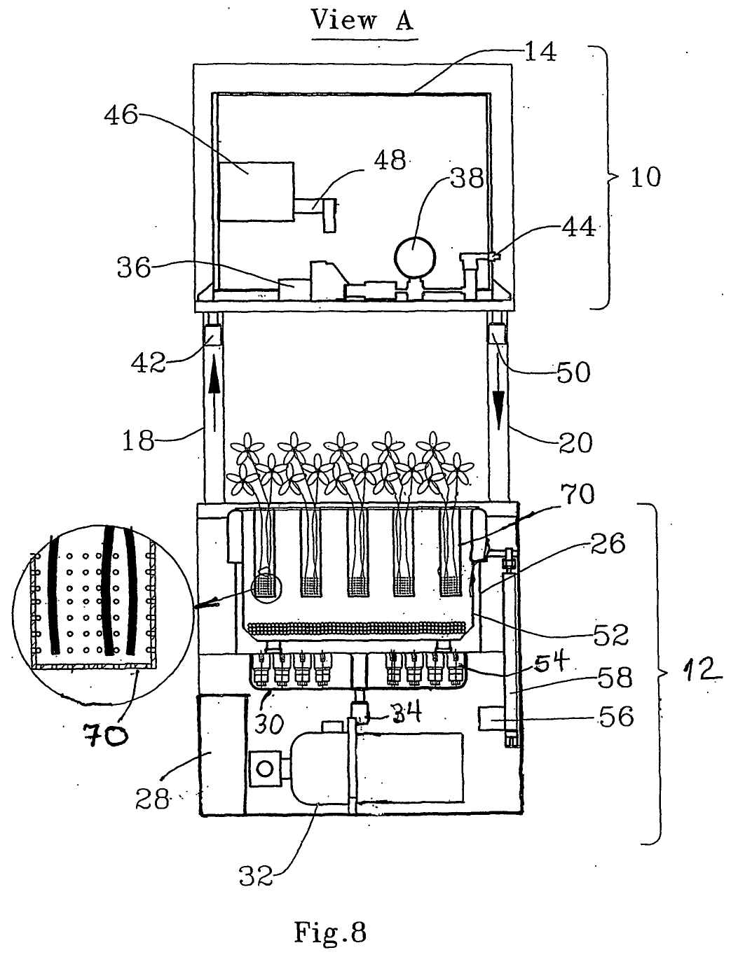

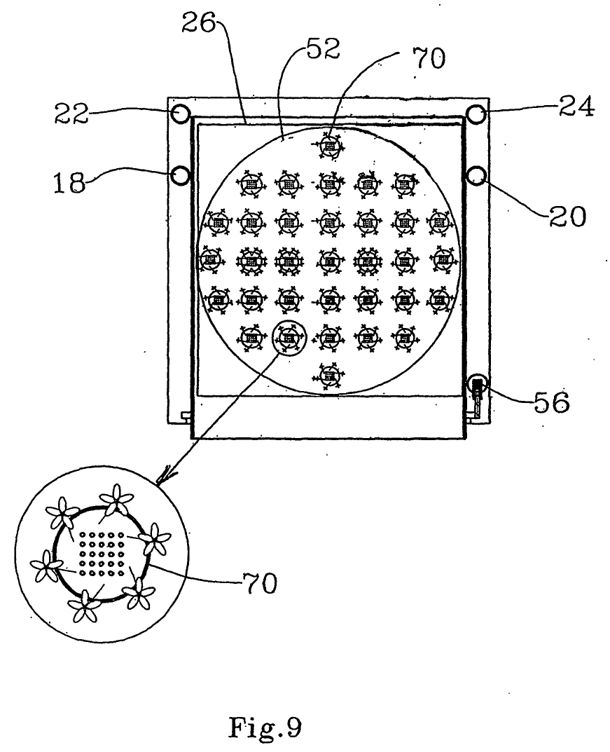

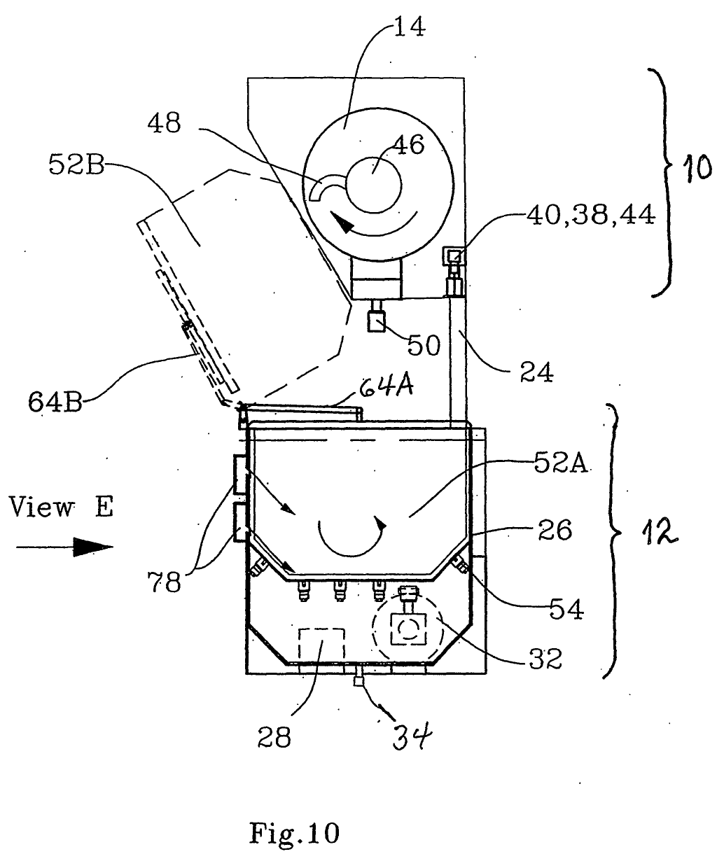

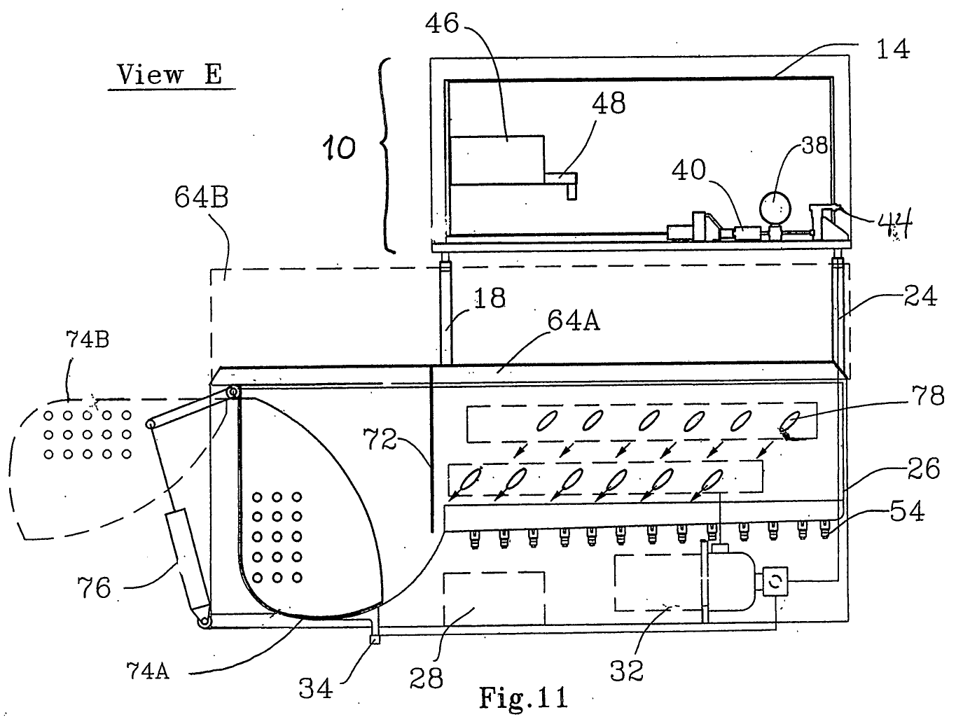

After cleaning and washing, an unloading means, such as an optional motorized basket drive unit 56 and a lifting mechanism 58, raises basket 52 at a steep angle (see FIG. 3, where the basket is depicted as raised from position 52A to 52B) to allow the cleaning items from the washing bath 26 to be drained of water and easily removed from washing bath 26. Water is drained from washing bath 26 through motorized drain valve 34. A rinse cycle is optional and may be done with basket 52 in either the raised or submerged position (positions 52A or 52B in FIG. 3), and either performed manually, or by use of an automatic sprinkler (not shown) disposed over the opening in washing bath 26 and connected to the water system and pre-programmed as part of the cleaning cycle.

Optionally, basket 52 is hand-removable and not integral to the apparatus of the invention and therefore does not require the motorized basket drive unit 56 and unloading mechanism 58 for unloading items place in the washing bath 26. The hand-removable basket 52 is a feature which makes the apparatus more economical to produce and therefore more suitable for use by small institutions and for non-commercial or domestic use.

FIG. 3 is a lateral view, in orthographic projection (View B, as indicated by the arrow in FIG. 1), of the embodiment of the apparatus of the invention shown in FIG. 1. In accordance with the option wherein the invention is provided with an electromechanical unloading means, as described in FIG. 2, basket 52 may be disposed in two positions: immersed position 52A within the water of washing bath 26, and in an upright position 52B, where the contents can be conveniently unloaded from the apparatus and removed for further processing.

FIG. 4 shows a top view (View C as indicated by the arrow in FIG. 1) of the lower unit 12 in an embodiment of the inventive apparatus of FIG. 1. The bottom of basket 52 is provided with a plethora of small, punched holes 60 to allow transmission of ultrasonic energy into the water surrounding the cleaning items in washing bath 26. There are also holes (not visible in this view) provided in the sidewalls of basket 52 to allow water circulation. Basket 52 may also be constructed of wire mesh or webbing to accomplish the same purpose. The circular arrows in FIG. 4 indicate the circulation of the water within basket 52 as impelled by operation of opposing water jets 62.

Items submerged in the water bath of washing bath 26 are caused to rotate by water jets 62. It is important not to introduce air into the system when a vacuum is used since this condition helps produce a higher cavitation energy level in the water per given amount of ultrasonic energy and can damage sensitive items immersed in the water.

The general placement of ultrasonic transducers 54 are shown in dashed lines to indicate their approximate location under washing bath 26 where they are in close proximity to the contents of basket 52. Transducers 54 generate micro-water vapor bubbles in the water in washing bath 26 for active cleaning of items placed in basket 52 as explained heretofore.

FIG. 5 is a front view of another embodiment of the apparatus of the invention wherein degassing is provided in the washing bath itself and not in a separate unit. In this embodiment, vacuum pump 36, vacuum gage 38, and an electromechanical valve 40 are all disposed in proximity to the washing bath 26 where the degassing takes place in a single unit in the space above the water used for washing and cleaning of the contents of basket 52.

After degassing, the water is alternatively made to circulate in pulses by jets of water introduced into the washing bath 26 from opposing water jet nozzles 62 (as in FIG. 4) to rotate the cleaning items within basket 52 and alternatively the water is set at rest to allow ultrasonic energy, generated from ultrasonic generator 28, to be transmitted through the water during these static periods in the washing cycle, creating a cavitation effect at the most effective times in the washing cycle while the water and cleaning items are at rest.

An additional feature in this embodiment is a cover 64 which is activated by a motorized drive unit (see 66 in FIG. 6) mounted at the rear of the washing bath 26. Cover 64, when closed, maintains an air-tight vacuum in washing bath 26 as needed. Ultrasonic transducers 54 disposed in an array within water-tight compartment 30 produce ultrasonic energy cavitation in the water of washing bath 26 which is in close proximity to transducers 54. An ultrasonic generator 28 provides the energy to the array of ultrasonic transducers 54. Other features are similar to those described heretofore.

FIG. 6 is a lateral view (View D as indicated by the arrow in FIG. 5), of the embodiment of the apparatus invention shown in FIG. 5 and indicates by dashed lines the unloading positions 64B and 52B of the cover 64A and basket 52A, respectively, in relation to washing bath 26. A motorized solenoid control 66 operates the opening and closing of the cover 64A/B in accordance with the washing cycle of the apparatus. An optional, hand-movable sprayer (not shown), disposed above the opening to water bath 26, is operated by a manual sprayer valve 65 connected to water pump 32 to initially rinse the contents of basket 52A/B with tap water.

FIG. 7 is a lateral orthographic view of yet another embodiment of the invention downsized and suitable for domestic use.

The washing apparatus of this embodiment is compact, but shares similar characteristics and features to the embodiments of the invention described in relation to FIGS. 1-4 and FIGS. 5-6, but does not have a vacuum pump and related electromechanical devices for degassing the water. Basket 52 is tightly sealed by a cover 64 which fits snugly over the opening of washing bath 26 to prevent unwanted water spills. Cover 64 optionally may be provided with a safety lock which is activated whenever ultrasonic energy is generated by ultrasonic generator 28. The ultrasonic generator 28, transducers 54 in transducer array unit 30, and water pump 32 are the key components in this embodiment for cleaning and washing items placed either directly into washing bath 26 or within basket 52 which may be removable for more convenient unloading of the contents after cleaning. Other electromechanical devices, such as valves, pumps, and meters, as may be necessary for the efficient operation of the washer apparatus of the invention are known to those skilled in the art, and, therefore, are herein generally represented by block 68.

FIG. 8 is a frontal view A′, of another embodiment of the apparatus of the invention of FIG. 1 illustrating a holding means especially adapted for flowering and long-stemmed plants.

Aside from the cleaning and washing benefits of the invention for flowers and long-stemmed and leafy vegetables, such as lettuce, parsley, dill, and the like, there is an added benefit provided by the cleaning process of the invention. This is the rejuvenation effect on plants by application of ultrasonic energy. Both the stems and leaves of flowers regain freshness and fullness of appearance after processing in the washing tank.

The enlargement in FIG. 8 illustrates the arrangement of fine holes in the holding means 70 (hereinafter called holders 70) which are constructed of porous cylinders submersible in washing bath 26. Holders 70 may have holes punched in them to make them porous or may be comprised of wire mesh or netting. Basket 52 is optional when this system is used, but may be left in place since it does not interfere with the cleaning of the flowers or plants placed in holders 70. Holders 70 provides separation of the cleaning items for more efficient and effective cleaning, while lending needed support for the stems of these cleaning items.

FIG. 9 is a top view C′ of the lower unit of an embodiment of the invention of FIG. 8 illustrating an example for the arrangement of holders 70 comprising flower-holding cylinders. An enlargement shows in detail the general placement of flowers around a typical holder 70, which, in the example shown, is a cylindrical container with holes provided in the base for facilitating absorption of ultrasonic energy when holders 70 are immersed in water bath 26 during the cleaning cycle of the apparatus. Other features are as hereinbefore described.

The quantity of flowering plants in each one of holders 70 depends on the type of flower, and characteristics such as size, length, number and configuration of leaves, and the like. The ultrasonic energy applied for cleaning is likewise dependent and adapted in duration and intensity in accordance with the requirements of flower types and the quantity of plants to be cleaned.

FIG. 10 is a lateral view of yet another embodiment of the apparatus of the invention providing for an unloading means in a continuous washing process.

Basket 52B, marked by dashed lines, is shown disposed in a manner to facilitate unloading items, while when in the position immersed in washing bath 26, the basket is noted as basket 52A. Cover 64A and its associated lifting mechanism (not shown in this view) follows basket 52A when removed from washing bath 26 and is marked in its upward position as cover 64B, also indicated in an alternative position by dashed lines.

Items for cleaning are propelled and rotated in the water bath 26 from the action of jets of water (indicated by arrows in bath 26) introduced at a plurality of nodes 78 along the length of washing bath 26.

FIG. 11 is a front view (View E in FIG. 10) of the embodiment of the invention of FIG. 10 for continuous processing of cleaning items. It should be noted that a vortex, created by a plurality of water jets emanating from nodes 78 strategically placed within the washing tank, is used to drive water circulation. The unloading feature of this embodiment can also be continuous with a semi-submerged conveyer (not shown) which continuously lifts items for cleaning from the water using basket 74A as a scoop which is then rotated into an unloading position as indicated by basket 74B. Furthermore, the water can be refreshed by continuous water bleeding to the drain 34 and continuous replacement by airless water provided from degassing tank 14.

A rotatable barrier gate 72 blocks items not yet cleaned from reaching basket 74A while immersed in washing bath 26. A mechanical or electromechanical arm 76 operates to rotate basket 74A into the upward unloading position represented by basket 74B (indicated by dashed lines), conveniently dumping cleaned items external to the apparatus for removal. During unloading, barrier gate 72 is also rotated so as to enable the contents of washing bath 26 to exit the apparatus.

In the continuous process of cleaning, the water is circulated and, in contrast to the batch processing embodiments shown heretofore, the cleaning items are pushed forward until they are unloaded by unloading basket 74A/B. As the cleaning items move along the long section of the continuous process embodiment of the apparatus invention, the action of the water circulation from the plurality of water impellers 78 causes the cleaning items to rotate and expose all surfaces to cleaning. Cover 64A/B enables cleaning under vacuum and is an optional feature not required if open cleaning under atmospheric pressure is the operational environment The water jets are pulsating in alternated cycles and in a manner as described hereinbefore. It should be noted that the strategically disposed water jets at nodes 78 are optionally employed for quick deceleration of the revolving water and any contents immersed therein in accordance the principles and method of the invention.

The continuous process embodiment of the apparatus of the invention illustrated in FIGS. 10 and 11 also has the cycles of rotating and halting periods as in the batch process embodiments of the apparatus described hereinbefore and also has the need for replacing the water after a pre-determined amount of cleaning items have been washed. For this need, a degassing tank is used. The water replacement can also be performed on a continuous basis.

Having described the present invention with regard to certain specific embodiments thereof, it is to be understood that the description is not meant as a limitation, since further modifications may now suggest themselves to those skilled in the art, and it is intended to cover such modifications as fall within the scope of the present invention.

We claim:

1. An ultrasonic cleaning and washing apparatus comprising:
a degassing means for providing degassed water for washing prior to initiating a washing and cleaning cycle;
a washing tank utilizing said degassed water and which accommodates at least one cleaning item;
an ultrasonic means to generate pulses of ultrasonic energy in said degassed water of said washing tank;
at least one water pumping means for circulating the water of said washing tank;
a water jetting means for directing a plurality of jets of water towards the at least one cleaning item to halt circulation and motion of water in said washing tank and concurrently to bring the rotation and motion of said at least one cleaning item to a halt within the shortest period of time;
a holding means for holding the at least one cleaning item oriented in the water of said washing tank so as to facilitate passage of ultrasonic energy through the water to optimally penetrate said at least one cleaning item immersed therein; and
a control means for programming and executing relevant process parameters in the operation of said ultrasonic cleaning apparatus for cycling said at least one cleaning item in an appropriate cleaning cycle.

2. An ultrasonic cleaning and washing apparatus as in claim 1, further providing:
a cover for said washing tank to prevent air intrusion and to contain said at least one cleaning item in a submerged position when said washing tank is filled with water.

3. A method for cleaning and washing at least one cleaning item comprising the steps of:
degassing a quantity of water in a degassing water tank prior to introducing said quantity of water into a washing tank;
placing said at least one cleaning item in a holding means within said washing tank;
supplying said quantity of water from said degassing water tank to said washing tank to a level enabling said holding means containing said at least one cleaning item to be submerged in said quantity of water;
adding given amounts of prescribed mixtures of active cleaning agents to said washing tank to enhance cleaning, disinfecting and decontaminating of said at least one cleaning item;
introducing ultrasonic energy into the water of said washing tank in a cleaning cycle of alternating cycles of cleaning and washing;
subjecting said at least one cleaning item to said alternating cycles of cleaning and washing by selecting relevant and suitable process parameters from operating controls provided on said apparatus itself;
creating turbulence in said water in said washing tank in said washing cycle of said alternating cycles so as to prevent air intrusion and to cause said at least one cleaning item in said washing tank to be agitated and to revolve, thereby exposing all surfaces to cleaning action;
removing said at least one cleaning item from said washing tank; and
rinsing the treated and cleaned said at least one cleaning item under tap water.

4. The apparatus of claim 1, further comprising a cover for said washing tank to prevent air intrusion and to contain said at least one cleaning item in a submerged position when said washing tank is filled with water.

5. The apparatus of claim 1 wherein said degassing means comprises a water degassing tank for storing and degassing water provided to said cleaning and washing apparatus; a water circulating pump for circulating water to and from said tank; a vacuum pump for providing degassing of said tank chamber; a vacuum gage for monitoring the degassing process; at least one solenoid valve for evacuating and inputting air to said degassing tank; a water level sensor for monitoring the level of the water in said degassing tank; and input and output solenoid valves to enable controlled operation of the entry and transfer of water to and from said degassing means.

6. The apparatus of claim 1 wherein said ultrasonic means comprises at least one array of ultrasonic transducers positioned in close proximity to said washing tank for creating turbulence in said water provided to said washing tank.

7. The apparatus of claim 1 wherein said control means comprises an electromechanical control system.

8. The apparatus of claim 1 wherein said washing tank contains a basket for securely accommodating said at least one cleaning item in a submerged state during a washing cycle.

9. The apparatus of claim 8 wherein said basket is removable so as to unload said at least one cleaning item from said washing tank.

10. The apparatus of claim 8 wherein said basket is rotatable within said washing tank so as to provide an unloading means to remove said at least one cleaning item from said washing tank after said at least one cleaning item has been cleaned and washed.

11. The apparatus of claim 10 wherein said unloading means comprises a basket drive unit for lifting out said basket from said washing tank in a manner to release said at least one cleaning item from said apparatus.

12. The method of claim 3 further comprising the steps of:
applying a vacuum to said washing tank containing said at least one cleaning item to enhance the cleaning process and improve the effectiveness of said active cleaning agents added to said water in said washing tank; and
providing an unloading means for removing said at least one cleaning item from said washing tank.

13. The method of claim 3 wherein said at least one cleaning item comprises plants characterized as at least one of the conditions of wilted, bent, and non-fresh.

14. The method of claim 3 wherein said degassing means provides degassed water for washing on a continuous basis to said washing tank.
